(19) United States
(12) Patent Application Publication
(10) Pub. No.: US 2017/0128808 A1
(43) Pub. Date: May 11, 2017

(54) ANALYSIS OF SWIMMING TECHNIQUE

(71) Applicant: Teknologian tutkimuskeskus VTT Oy, Espoo (FI)

(72) Inventor: Ari AUVINEN, VTT (FI)

(21) Appl. No.: 15/348,517

(22) Filed: Nov. 10, 2016

(30) Foreign Application Priority Data
Nov. 11, 2015 (FI) 20155832

(51) Int. Cl. A63B 69/12; G09B 19/00; A63B 24/00; G01L 5/00

(52) U.S. Cl. CPC A63B 69/12; G01L 5/0038; G09B 19/0038; A63B 24/0006; A63B 2220/836; A63B 2220/56; A63B 2220/40; A63B 2208/03; A63B 2244/20

(57) ABSTRACT

A method and system for analyzing swimming technique, the method comprising measuring pressure exerted on the hand during a handstroke with at least one pressure sensor (12) attached to a hand of a swimmer; measuring acceleration in three dimensions during the handstroke with at least one acceleration sensor (13) attached to the hand of the swimmer; and calculating from the measured values a profile of the handstroke comprising a quantity and direction of the force during the handstroke.

### TECHNICAL FIELD

The present application generally relates to sports measurement. In particular, but not exclusively, the present application relates to measurement and analysis of swimming technique.

### BACKGROUND

This section illustrates useful background information without admission of any technique described herein being representative of the state of the art.

A swimming technique of a swimmer is in large part dependent on the handstrokes used by the swimmer. Accordingly, an analysis of swimming technique requires an analysis of the handstrokes of the swimmer.

Previously, handstrokes of the swimmer have been studied with bulky setups not consistent with normal training or swimming conditions such as using countercurrent pools or attaching a swimmer to rope in order to test the pulling strength. Furthermore, video analysis systems for analyzing swimming technique have been previously presented, but these require an extensive and expensive setup in the pool.

Recently, wrist devices have been used to measure the distance the swimmer has completed and some wrist devices are even able to recognize the technique after being trained to do so by the swimmer, but they cannot analyze the quality thereof. Furthermore, swimming paddles used in training have been presented with integrated sensors for recording e.g. speed or force. An example of such a paddle has been disclosed in patent publication U.S. Pat. No. 6,183,396 B1.

It is the objective of the invention to provide a method and apparatus for analyzing swimming technique that mitigates for example the above issues of the prior art and provides a method and system for a more detailed analysis of swimming technique.

### SUMMARY

Various aspects of examples of the invention are set out in the claims.

According to a first example aspect of the present invention, there is provided a method for analyzing swimming technique, comprising

measuring pressure exerted on the hand during a handstroke with at least one pressure sensor attached to a hand of a swimmer;

measuring acceleration in three dimensions during the handstroke with at least one acceleration sensor attached to the hand of the swimmer; and

calculating from the measured values a profile of the handstroke, wherein

the profile of the handstroke comprises a quantity and direction of the force during the handstroke.

The method may further comprise sending the measured values after the handstroke to an analyzing element.

Sending the measured values may comprise sending via Bluetooth.

The method may further comprise measuring pressure with at least two sensors during the handstroke.

The pressure exerted on the hand may be measured with a first pressure sensor and the hydrostatic pressure may be measured with a second pressure sensor.

Calculating the profile may comprise calculating from values measured during several handstrokes.

The method may further comprise receiving after the handstroke a feedback signal from the analyzing element; and providing a feedback to the swimmer based on the feedback signal.

The method may further comprise attaching the at least one pressure sensor and the at least one acceleration sensor to a wearable element; and attaching the wearable element to the hand of the swimmer.

The wearable element may comprise a paddle.

The method may further comprise storing the measured values to a memory element attached to the hand of the swimmer.

According to a second example aspect of the present invention, there is provided a system for analyzing swimming technique, comprising

a measuring element configured to be attached to a hand of a swimmer, the measurement element comprising

at least one pressure sensor;

at least one acceleration sensor;

a memory element;

a communications element; and

a processor;

an analyzing element; wherein

the processor and the analyzing element are configured to cause carrying out the method of the first example aspect.

The system may further comprise a wearable element configured to be attached to the hand of the swimmer and comprising the measuring element.

The analyzing element may comprise a mobile electronic device.

According to a third example aspect of the present invention, there is provided a computer program comprising computer code for causing performing the method of the first example aspect, when executed by a processor.

According to a fourth example aspect of the present invention, there is provided a non-transitory memory medium comprising the computer program of the third example aspect.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows a principle view of the system according to an embodiment of the invention;

FIG. 2 shows a schematic block diagram of the system according to an embodiment of the invention;

FIG. 3 shows an example of a flow diagram of a method according to an embodiment of the invention; and

FIG. 4 shows an example handstroke profile calculated according to an embodiment of the invention; and

FIG. 5 shows an example handstroke profile showing forces as vectors as a function of time during one handstroke calculated according to an embodiment of the invention.

### DETAILED DESCRIPTION OF THE DRAWINGS

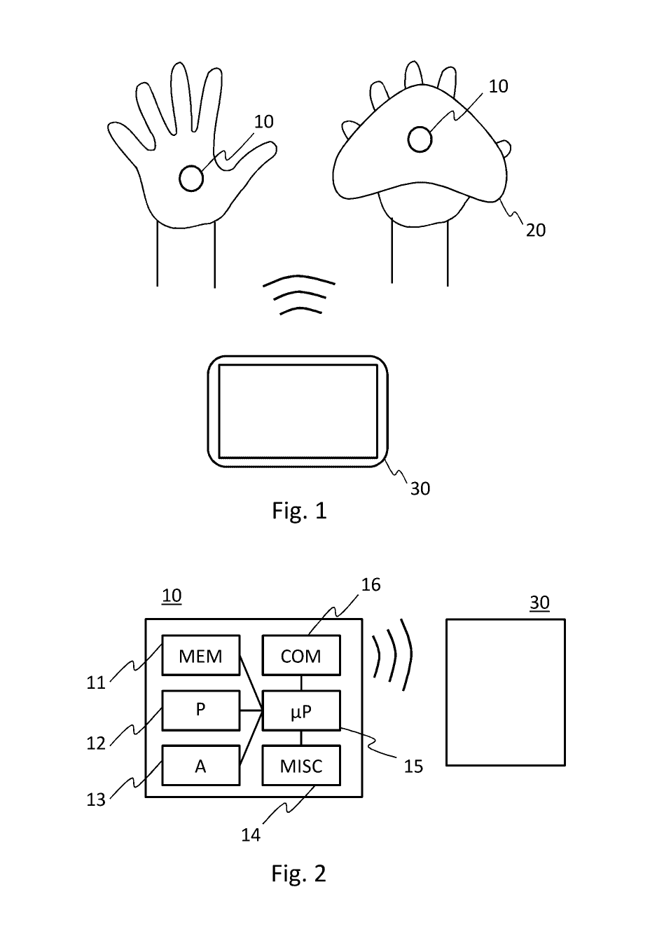

The present invention and its potential advantages are understood by referring to FIGS. 1 through 5 of the drawings. In this document, like reference signs denote like parts or steps.

FIG. 1 shows a principle view of the system according to an embodiment of the invention. The system in an embodiment comprises a measurement element 10 attached to a palm of a hand of a user, i.e. a swimmer, in such a way that the orientation of the measuring element is known. In an example embodiment, the measurement element is attached directly to the hand of a user for example by a strap or attaching substance, such as water resistant glue. In a further embodiment, the measuring element 10 is attached first to a wearable element 20, such as a swimmer's hand paddle as shown in FIG. 1. Attaching the measuring element 10 to a wearable element allows for easy use of the measuring element 10 with a wearable element 20 to which the user is already accustomed. In a further embodiment, the wearable element 20 comprises a ringlike element that is placed around one or several fingers of the user. In a still further embodiment, the wearable element 20 comprises a wrist-word element, such as a heart rate monitor, a smartwatch or activity bracelet, attached to the wrist in such a way that the orientation of the measuring element 10 remains stable during use.

The measuring element 10 comprises communication means, or interface, for communicating wirelessly with an analyzing element 30. In an embodiment, the communication is arranged via communication protocol such as Bluetooth, wireless local area network or mobile network. In an embodiment, the analyzing element 30 comprises an electronic device such as a smartphone, a tablet computer, a computer, a server or a cloud based system. In a further embodiment, the analyzing element 30 comprises software, i.e. an app, installed in the device.

The analyzing element 30, in an embodiment, is configured to be connected, or paired, to several measuring elements 10, so that the analyzing element is in communication with measuring elements attached to both hands of a user, or with measuring elements 10 attached to several users. In an embodiment, the analyzing element comprises user interface means, such as a display for displaying the results of the analysis and a touchscreen or a keyboard for user input.

The measuring element 10 comprises a watertight cover, package or encapsulation. In an embodiment, the measuring element 10 is completely sealed, i.e. the measuring element 10 has no holes, inlets or ducts. In an embodiment, the package of the measuring element has a flexible element configured to allow the pressure to be sensed by a pressure sensor inside the package. Such a flexible element comprises in an embodiment a flexible cover or cap, or membrane or diaphragm for example made of silicone.

FIG. 2 shows a schematic block diagram of the system according to an embodiment of the invention. The measuring element 10 comprises a memory element 11 configured e.g. to store measurement values, a communications element 16 configured to send and receive data wirelessly and a processor 15 configured to control the measuring element 10 and to cause the measuring element to 10 to carry out a method according to an embodiment of the invention.

The measuring element 10 further comprises at least one pressure sensor 12 configured to measure pressure incident on the measuring element, i.e. on the hand of the swimmer. In a further embodiment, the measuring element 10 comprises at least two pressure sensors configured to measure with a first sensor the pressure incident on the hand of the swimmer and with a second sensor hydrostatic pressure. The measuring element 10 further comprises at least one acceleration sensor 13 configured to measure acceleration in three dimensions. In an embodiment, the measuring element 10 comprises further elements 14, such as further sensors including temperature sensors, moisture sensors and a gyroscope. In a still further embodiment, the further elements 14 comprise at least one actuator configured to provide feedback with a tactile sensation for the user for example by vibrating.

The communication element 16 is configured to communicate with the analyzing element 30 over one or more local links or telecommunication links suited for establishing links with other users or for data transfer (e.g. using the

Internet). Such telecommunication links in an embodiment comprise wireless local area network links, Bluetooth, ultra-wideband, cellular or satellite communication links. While FIG. 2 shows one communication element 16, the measuring element 10 in an embodiment comprises a plurality of communication elements 16. In a further embodiment, the measuring element 10 is configured to communicate with a further communication element attached to a further device, such as a wrist worn device configured to relay the data from the measuring element 10 to the analyzing element. The communication element 16 is, in an embodiment, controlled by the processor 15, to establish communications and send the measured data during the time the hand of the swimmer is above the water surface. In a further embodiment, the communications element 16 is, controlled by the processor 15, configured to establish communications also when submerged. In an embodiment, the processor 15 is further configured to carry out at least some calculations or pre-processing in order to reduce the amount of data sent to the analyzing element 30.

The processor 15 is, for example, a central processing unit (CPU), a microprocessor, a digital signal processor (DSP), a graphics processing unit, an application specific integrated circuit (ASIC), a field programmable gate array, a microcontroller or a combination of such elements. FIG. 2 shows one processor 15, but the measuring element 10 in an embodiment comprises a plurality of processors.

The memory 11 may comprise volatile and a non-volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or any combination thereof. In an embodiment, the apparatus comprises a plurality of memories. The memory 11 in an embodiment is configured to serve the sole purpose of storing data, or it is in an embodiment configured to serve other purposes, such as processing data.

In a further embodiment, the measuring element 10 comprises still further elements, such as control element or elements, for example a button for switching the measuring element on and off. Additionally, the measuring element 10 comprises a disposable or rechargeable battery (not shown) for powering the apparatus. In further embodiment, the measuring element 10 comprises a battery configured to be recharged wirelessly.

In a further embodiment, some elements of the measuring element 10 are instead or in addition to the measuring element formed as a part of the wearable element 20 to which the measuring element is attached.

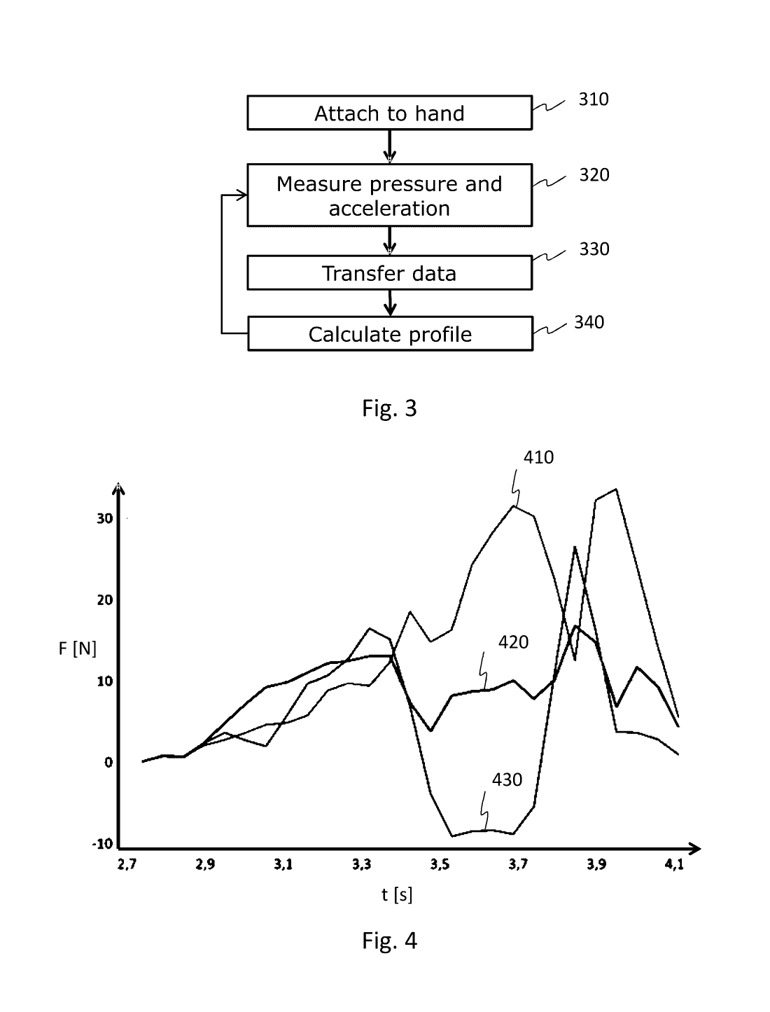

FIG. 3 shows a flow diagram of a method according to an embodiment of the invention. At step 310, the measuring element 10 is attached to the hand of the user as hereinbefore described with reference to FIG. 1. The measuring element 10 per se is either attached or the wearable element 20 with the measuring element 10 is attached.

At step 320 the pressure incident on the measuring element, i.e. the pressure incident on the hand of the swimmer is measured with at least one pressure sensor 12. In an embodiment, the hydrostatic pressure is measured as well with a further pressure sensor. Simultaneously, the acceleration of the hand of the swimmer is measured in three dimensions with the at least one acceleration sensor 13. The measurements, i.e. the measured data or values, are in an embodiment stored at least intermittently, to the memory 11.

At step 330 the measured values, i.e. the data, is transferred. In an embodiment, the data is transferred vie e.g. Bluetooth as hereinbefore described during the time of the handstroke that the hand is above the water surface or near to the water surface. In a further embodiment, the data might be transferred more often, also while the hand is submerged, e.g. using a further communications element attached to the swimmer to relay the data. The data is transferred, i.e. sent via the communications element 16, to the analyzing element 30, for example to a mobile device used by a coach of the swimmer. In an embodiment, the processor 15 is further configured to carry out at least some calculations or pre-processing in the measuring element 10 in order to reduce the amount of data sent to the analyzing element 30.

At step 340, a profile of the handstroke is calculated from the measured values, i.e. from the data received from the measuring element 10. The acceleration values and the pressure values are used to calculate a profile comprising the quantity of the force of the stroke, as well as a direction of the force.

In an embodiment, the acceleration data is further used to calculate the depth of the hand at each time, in order to know the hydrostatic pressure. In an embodiment, the processor of the measurement element is configured to cause, prior to sending the data, carrying out processing operations on the data, such as for example filtering. In an embodiment, the profile is calculated in real-time after each handstroke, in a further embodiment, the profile is calculated from measurement values of several handstrokes and/or updated with the information of each new handstroke.

The calculated profile is in an embodiment displayed on a display and stored at the analyzing element. In further embodiment, the analysis element 30 is configured to, after calculating the profile, based on user input and/or based on predefined parameters, such as force falling under a threshold value, to send a feedback signal to the measuring element 10 causing an actuator to give a tactile sensation to the user e.g. by vibrating the measuring element.

FIG. 4 shows an example handstroke profile calculated according to an embodiment of the invention. The profile shows the quantity and direction of the force during a handstroke with respect to time. The line 410 shows the quantity of the force backwards, the line 420 shows the quantity of the force downwards and the line 430 shoes the quantity of the force sideways. The negative forces correspond to the opposite direction.

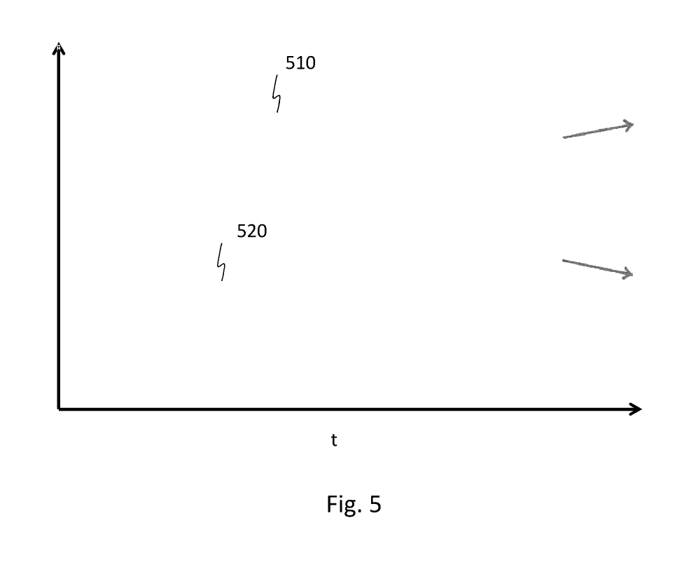

FIG. 5 shows an example handstroke profile showing forces as vectors as a function of time during one handstroke calculated according to an embodiment of the invention. Graph 510 shows a top view of the handstroke showing the direction and the magnitude of the force in sideways and backward directions as the time progresses from left to right. Graph 520 shows a side view of the handstroke showing similar information of the forces to downward and backward directions.

Without in any way limiting the scope, interpretation, or application of the claims appearing below, a technical effect of one or more of the example embodiments disclosed herein is an improved analysis of swimmers handstroke. Another technical effect of one or more of the example embodiments disclosed herein is simple an cost-effective analysis. Another technical effect of one or more of the example embodiments disclosed herein is provision of analysis without influencing the swimming with equipment the swimmers are not used to. A still further technical effect of one or more of the example embodiments disclosed herein is the provision of real-time monitoring of the technique in training. A still further technical effect of one or more of the example embodiments disclosed herein is the provision of analyzing possibility for different swimming styles.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope of the present invention as defined in the appended claims.

1. A method for analyzing swimming technique, comprising measuring pressure exerted on the hand during a handstroke with at least one pressure sensor (12) attached to a hand of a swimmer;
measuring acceleration in three dimensions during the handstroke with at least one acceleration sensor (13) attached to the hand of the swimmer; and
calculating from the measured values a profile of the handstroke, wherein
the profile of the handstroke comprises a quantity and direction of the force during the handstroke.

2. The method of claim 1, further comprising sending the measured values after the handstroke to an analyzing element (30).

3. The method of claim 2, wherein sending the measured values comprises sending via Bluetooth.

4. The method of claim 1, further comprising measuring pressure with at least two sensors during the handstroke.

5. The method of claim 4, wherein the pressure exerted on the hand is measured with a first pressure sensor and the hydrostatic pressure is measured with a second pressure sensor.

6. The method of claim 1, wherein calculating the profile comprises calculating from values measured during several handstrokes.

7. The method of claim 1, further comprising receiving after the handstroke a feedback signal from the analyzing element; and providing a feedback to the swimmer based on the feedback signal.

8. The method of claim 1, further comprising attaching the at least one pressure sensor (12) and the at least one acceleration sensor (13) to a wearable element (20); and attaching the wearable element to the hand of the swimmer.

9. The method of claim 8, wherein the wearable element comprises a paddle.

10. The method of claim 1, further comprising storing the measured values to a memory element (11) attached to the hand of the swimmer.

11. A system for analyzing swimming technique, comprising a measuring element (10) configured to be attached to a hand of a swimmer, the measurement element comprising
at least one pressure sensor (12);
at least one acceleration sensor (13);
a memory element (11);
a communications element (16); and
a processor (15);
an analyzing element (30); wherein
the processor and the analyzing element (30) are configured to cause carrying out the method of any preceding claim.

12. The system of claim 11, further comprising a wearable element (20) configured to be attached to the hand of the swimmer and comprising the measuring element (10).

13. The system of claim 11, wherein the analyzing element (30) comprises a mobile electronic device.

14. A computer program comprising computer code for causing performing the method of claim 1, when executed by a processor.

15. A non-transitory memory medium comprising the computer program of claim 14.
